(19) United States
(12) Patent Application Publication
(10) Pub. No.: US 2012/0321836 A1
(43) Pub. Date: Dec. 20, 2012

(54) VARIABLE-THICKNESS ELECRIPLAST MOLDABLE CAPSULE AND METHOD OF MANUFACTURE

(75) Inventor: Thomas Aisenbrey, Littleton, CO (US)

(73) Assignee: INTEGRAL TECHNOLOGIES, INC., Bellingham, WA (US)

(21) Appl. No.: 13/572,163

(22) Filed: Aug. 10, 2012

Related U.S. Application Data
(63) Continuation of application No. 11/983,363, filed on Nov. 8, 2007.
Application No. 11/983,363 is a continuation-in-part of application No. 11/796,680, filed on Apr. 28, 2007, now abandoned.
Application No. 11/796,680 is a division of application No. 10/883,915, filed on Jul. 1, 2004, now Pat. No. 7,223,469.
Application No. 10/883,915 is a continuation-in-part of application No. 10/887,092, filed on Jul. 9, 2004, now Pat. No. 6,931,760.
Application No. 10/887,092 is a continuation of application No. 10/309,429, filed on Dec. 4, 2002, now Pat. No. 6,870,516.
Application No. 10/309,429 is a continuation-in-part of application No. 10/075,778, filed on Feb. 14, 2002, now Pat. No. 6,741,221.
(60) Provisional application No. 60/317,808, filed on Sep. 7, 2001.
(60) Provisional application No. 60/269,414, filed on Feb. 16, 2001.
(60) Provisional application No. 60/268,822, filed on Feb. 15, 2001.

(51) Int. Cl. B32B 3/02; B29C 47/02

(52) U.S. Cl. 428/80; 264/104

(57) ABSTRACT

A moldable capsule device (1) includes a bundle of micron conductive fiber (3) and a resin-based material layer (5) overlying the bundle along the length (L) of the capsule wherein thickness of the resin-based material layer is not uniform (T1 and T2), A method (100) to form a moldable capsule (1) including extruding/pultruding a resin-based material layer (5) onto the length (L) of a bundle of micron conductive fiber (3), The resin-based material layer (5) has a first thickness (T1) and a second thickness (T2), The first thickness (T1) is disposed around multiple first surfaces (7) of the bundle. The second thickness (T2) is disposed around multiple second surfaces (9) of the bundle. The second thickness (T2) is at least twice that of the first thickness (T1). The extruded/pultruded resin-based material and bundle are section into moldable capsules.

This Patent Application is a Continuation-in-part of U.S. patent application Ser. No. 11/796,680 (INT03-020B), filed on Apr. 28, 2007, incorporated by reference in its entirety;
which is a Division of U.S. patent application Ser. No. 10/883,915 (INT03-020), filed May 1, 2004, now issued as U.S. Pat. No. 7,223,469, also incorporated, by reference in its entirety, which claimed priority to U.S. Provisional Patent Application Ser. No. 60/484,456 filed on Jul. 2, 2003, which is herein incorporated by reference in its entirety;
which is a Continuation In-Part of U.S. patent application Ser. No. 10/877,092 (INT01-002CIPC), filed on Jun. 25, 2004, also incorporated by reference in its entirety;
which is a Continuation of U.S. patent application Ser. No. 10/309,429 (INT01-002CIP), filed on Dec. 4, 2002, now issued as U.S. Pat. No. 6,870,516, also incorporated by reference in its entirety;
which is a Continuation-in-part application of U.S. patent application Ser. No. 10/075,778 (INT01-002), filed on Feb. 14, 2002, now issued as U.S. Pat. No. 6,745,221;
which claimed priority to U.S. Provisional Patent Application Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### FIELD OF THE INVENTION

This invention relates to conductive polymers useful for molding conductive articles usable within the EMF, thermal, acoustic, or electronic spectrum(s). More particularly, this invention relates to a moldable capsule including micron conductive fibers and resin-based material. Even more, particularly, the present relates to a uniquely-shaped moldable capsule, and method of manufacture thereof.

### BACKGROUND OF THE INVENTION

Resin-based polymer materials are used for the manufacture of a wide array of articles. These polymer materials combine many outstanding characteristics, such as excellent strength to weight ratio, corrosion resistance, electrical isolation, and the like, with an ease of manufacture using a variety of well-established molding processes. Many resin-based polymer materials have been introduced into the market to provide useful combinations of characteristics.

In a typical scenario, resin-based polymer materials are manufactured in bulk quantities by chemical manufacturers. The resin-based material is then typically combined with fillers, additives, colorants, lubricants, and other particular materials that are required for the molding application through a process called compounding. The compounded resin-based material is typically in the form of pellets, sheets, rods, or lumps. The compounded material is typically of uniform size, shape, and chemical constituency. At the molding operation, the compounded resin-based material is loaded into a molding apparatus, such as an injection-molding machine, compression molding machine or an extrusion machine, and melted during the molding cycle. The molten material is injected by force into a mold cavity, or through a molding die to form the desired shape.

In spite of many outstanding characteristics, resin-based polymer materials are unfortunately, typically poor conductors of thermal and electrical energy. Low thermal conductivity can be an advantageous in applications, such as cooking pan handles or electrical insulators. In other cases, however, resin-based materials known as insulators conduct thermal or electrical energy poorly and are not useful. Where high thermal or electrical conductivity is required, conductive metals, such as copper or aluminum or other metals, are typically used. A disadvantage of solid metal conductors is the density of these materials. For an example in electrical and thermal applications such as used in aircraft, satellites, vehicles, or even in hand held devices the weight due to solid metal conductors is significant. It is therefore desirable to replace solid metal conductors with less dense materials. Since resin-based materials are typically much less dense than metals, and can have the strength of metals, these materials would theoretically be good replacements for metals. However, the problems of low conductivity and doping must be resolved.

Attempts have been made in the art to create thermally and electrically conductive resin-based materials. There are two general classifications of such materials, intrinsically conductive and non-intrinsically conductive. Intrinsically conductive resin-based materials, which may also be referred to as conjugated resins, incorporate complex carbon molecule bonding within the polymer, increasing the conductivity of the material. Unfortunately, intrinsically conductive resin-based materials typically are difficult to manufacture, very expensive and are limited in conductivity. Non-intrinsically conductive resin-based materials, which also may be referred to as doped materials, are formed by mixing conductive fillers or dopants, such as conductive fibers, powders, or combinations thereof, within a base resin materials, resulting in increased conductivity in a molded form. Metallic and non-metallic fillers have been demonstrated in the art to provide substantially increased conductivity in a composite material while maintaining competitive cost

However, non-intrinsically conductive resin-based materials that have been demonstrated in the art forms suffer front several well-known problems. A first problem is poor structural material performance due to excessive conductive dopant loading. To achieve low resistivity, most prior art conductive resin-based materials require a conductive dopant percentage, that is so high that the specified base resin material properties are compromised. The resulting molded articles are weakened, brittle and thus commercially undesirable. In addition, the excessive conductive loading in the doped, materials prematurely wears molding machine components such as screws, barrels, and molds,

A second well-known problem in the art is the difficulty of the molding cycle to properly mix the base resin and conductive filler to create a molded article with consistent electrical, thermal, and mechanical properties. To create an optimally stable material, the conductive dopants must form an interconnected network within and throughout the polymer matrix of base, resin. To achieve a uniform conductive network, the conductive filler particles preferably have substantial length to width aspect ratios, are sized in proportion to the polymer chain molecules, and are substantially homogenized throughout the base resin. A high aspect ratio of the dopant particles increases the available contact points for each particle, extending the conductive network thru out the molded article or part. Appropriate particle size and allocation allows the conductive dopants to be dispersed within the polymer matrix without disrupting the polymer chains or adversely affecting the structural properties of the resin-based materials. Homogeneous dispersal of the conductive filler throughout the polymer matrix insures that the conductive network extends proportionately throughout the resin-based material. Intuitively, substantially homogeneous dispersal could be achieved through an extensive or aggressive molding cycle of the molding process. However, the conductive dopant particles are typically in microns in diameter, and these dopant particles can be adversely damaged or broken during melting, mixing and the forces of the molding cycle. If the conductive dopants become damaged, the aspect ratio of the dopant can be pulverized, and the multiple points of contact between conductive particles are then minimized. As a result, the conductive network aspect ratio is reduced resulting in low-level electrical, thermal and acoustical continuity within the formed article or molded part.

One prior art approach to molding a conductive resin-based material is the use of “concentrate” pellets and “salt and pepper” blends. Concentrate pellets comprise a bundle of conductive filler particles that are bound together by a minuet amount of a resin-based material. The resulting concentrate pellet acts as a carrier to provide a means for adding measured amounts of conductive concentrate combined with a natural plastic or resin based base material. The concentrate pellets bond with only minimal amounts of base resin material are not capable as a standalone molding material due to the high concentration of filler particles. Therefore, a substantial quantity of pure resin-based pellets must be added to the concentrate pellets to produce a moldable blend. This dry blend mixture of concentrate pellets and base resin pellets are loaded into the hopper of a molding machine forming a blend that is commonly called a “salt and pepper” mixture. This two part dry blend is then gravity fed into the barrel of the molding machine heated and further mixed, melted, and compressed as it travels through the molding machine screw and barrel zones. The conductive filler particles are released from the concentrate pellets during melting and, are then dispersed throughout the mixture. The molten mixture is then forced, or shot, under high pressure into a mold cavity to form a molted article or part. Shear forces and pressures within the molding cycle, may cause damage the conductive particles while further damaging and decreasing the aspect ratio of conductive particles due to the time release of the particles in a thin wall carrier of a concentrate.

The “salt and pepper” blend that is transformed from the combination of pure resin-based pellets and concentrate pellets into a mixture exhibits several shortcomings. First, it is very difficult, if not impossible, to create a uniform homogeneous mixing of the filler material throughout the molten plastic using this technique for several reasons. First the concentrate pellets have a different specific gravity than the base resin pellets, and while being gravity fed thru a hopper in conjunction with the base resin pellets they will not feed into the machine at an equal rate, thus the concentrations are not equal within the base resin. Also as the pellets begin to melt making their way thru the different zones of the screw and barrel of the molding machine, they will exhibit a different resonating frequency exhibiting different flow behaviors. As a result, substantial variation is seen in the concentration of conductive filler within the base resin. Second, during the molding cycle, the filler particles in the molten mixture may fail to properly wet or disperse within molten base resin. The lack of a full wet out as a result of the time and material release during the molding cycle, results in the conductive additives to form clumps, begin ganging, swirls, or what can be termed as hot spots within the resin as the materials have difficulty mixing. Further, these clumps, gangs, and swirls create voids within the polymer chains, resulting in weak spots and voids, constituting structural incompatibility destroying the base resins mechanical characteristics.

Another problem with prior art “salt and pepper” blending of concentrate pellets and pure resin-based pellets is chemical interaction that may occur between dissimilar materials. In particular, the carriers, or coatings, that hind together the conductive filler In the concentrate pellets can adversely chemically react with the base resin, creating unpredictable chemical and/or structural reactions that can lead to unpredictable and potentially very dangerous gassing, catastrophic failure and other damaging human and or equipment damaging circumstances. These material interactions are especially likely where the concentrate pellets are formed using two or more resin-based materials—a first material to bind the strands and a second material to form an outer coating or carrier. As a result, in a “salt and pepper” mix of concentrate and base resin pellets, a combination of three different resin-based materials is created. With over 15,000 commercially available base resins, it is important not to introduce resin-based materials into the concentrate carrier or outer coating that can react with any of the vast variety of pure engineered molding resins. In addition to unpredictable chemical reactions, is that different types of resin-based materials may exhibit different flow behaviors. It is found that “salt and pepper” blends result in electrically, thermally, mechanically, and acoustically inconsistent, unstable, structurally weakened, and/or poor quality molded articles and parts.

U.S. Pat. No. 7,223,469, referenced above, addressed the problems of the “salt and pepper” blending by introducing a moldable capsule that did not require “salt and pepper” blending. This moldable capsule contained a substantially higher micron conductive fiber loading such that a proper doping level for excellent molded article performance was achieved without “salt and pepper” mixing.

In the present invention, the qualities of the moldable capsule are further improved by the development of a variable-thickness moldable capsule. In particular, the variable-thickness moldable capsule features a unique cross-sectional design combining thick regions and thin regions of resin-based material. The resulting capsule exhibits effective time release of conductive dopant during pre-mold mix, substantial homogenization of dopant and resin-based material, and optimal doping levels without “salt and pepper” mixing.

### BRIEF DESCRIPTION OF THE DRAWINGS

The present invention and the corresponding advantages and features provided thereby will be best understood and appreciated upon review of the following detailed description of the invention, taken in conjunction with the following drawings, where like numerals represent like elements, in which:

FIGS. 1a and 1b illustrates a preferred embodiment of a variable-thickness moldable capsule of the present invention. FIG. 1a shows a cross-section taken perpendicular to the length of the moldable capsule and indicates a “bowtie-shaped” type of cross-section. FIG. 1b shows a lengthwise side view of the moldable capsule.

FIG. 2 illustrates a preferred embodiment of the present invention showing a variable-thickness moldable capsule with a “gear-shaped” type of cross-section.

FIG. 3 illustrates a preferred embodiment of the present invention showing a variable-thickness moldable capsule with a “star-shaped” type of cross-section.

FIG. 4 illustrates a preferred embodiment of the present invention showing a method to manufacture a moldable capsule.

FIG. 5 illustrates a preferred embodiment of the present invention showing a cross section of a crosshead extrusion die of the present invention.

FIG. 6 illustrates a preferred embodiment of the present invention showing an end view of a cross head extrusion die of the present invention.

FIG. 7 illustrates a preferred embodiment of the present invention showing an extruder system for forming the moldable capsule.

FIG. 8 illustrates a preferred embodiment of the present Invention showing an extruder system for forming the moldable capsule where chopped fiber is added to the resin-based extrusion material.

FIG. 9 illustrates a preferred embodiment of the present invention showing an extruder system tor forming the moldable capsule where fiber is blown into the resin-based extrusion material.

### DESCRIPTION OF THE PREFERRED EMBODIMENTS

A moldable capsule includes an inner core comprising micron conductive fiber and an outer layer comprising resin-based material, surrounding the length of the inner core, and having a cross-sectional shape with more than one thickness. The resulting moldable capsule is exceptionally useful for molding a wide variety of articles. Homogenous mixing of micron fiber and base resin, essential to the optimal formation of conductively doped, resin-based material, may be achieved by preparing the novel moldable capsule in a typical resin molding apparatus using low to moderate pressures and within lisle breakage of fiber.

The moldable capsules of the present invention may be used to mold articles of conductively doped resin-based materials. Conductively doped resin-based materials are base resins doped with conductive materials. Doping transforms the base resin into a conductor rather than an insulator. The resins provide the structural integrity to the molded part. The micron conductive fibers, micron conductive powders, or a combination thereof, are substantially homogenized within the base resin during the molding process, providing the electrical, thermal, and acoustical continuity.

The conductively doped resin-based materials can be molded, extruded or the like to provide almost any desired shape or size. The molded conductively doped resin-based materials can also be cut, stamped, or vacuumed formed from an injection molded or extruded sheet or bar stock, over-molded, laminated, milled, or the like, to provide the desired shape and size. The thermal, electrical, and acoustical continuity and or conductivity characteristics of articles or parts fabricated using conductively doped resin-based materials depends on the composition of the conductively doped resin-based materials, of which the doping parameters and or materials can be adjusted, to aid in achieving the desired structural, electrical or other physical characteristics of the then molded material. The selected materials used to fabricate the articles are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In the conductively doped resin-based material, electrons travel from point to point, following the path of least resistance. Most resin-based materials are insulators and represent a high resistance to electron passage. The doping within the resin-based material alters the inherent resistance of the polymers. At a threshold concentration of conductively doping, the resistance through the combined mass is lowered enough to allow electrons movement. Speed of electron movement depends on conductive doping concentration and the materials chemical make up, that is, the separation between the conductive doping particles. Increasing conductive doping content reduces interparticle separation distance, and, at a critical distance known as the percolation point, resistance decreases dramatically and free electrons move rapidly.

Resistivity is a material property that depends on the atomic bonding of the microstructure of the material. The atomic microstructure material properties within the conductively doped resin-based material are altered when molded into a structure. A substantially homogenized conductive microstructure of delocalized valance electrons is created within the valance and conduction bands of the said molecules. This micro-structure provides sufficient charge carriers within the molded matrix structure. As a result, a low density, low resistivity, lightweight, durable, resin, based polymer microstructure material is achieved. This material can exhibit conductivity comparable to that of highly conductive metals such as silver, copper or aluminum, while maintaining the superior structural characteristics found in many plastics and rubbers or other structural resin based materials.

The use of conductively doped resin-based materials in the fabrication of articles and parts significantly lowers the cost of materials and the design and manufacturing processes used to hold ease of close tolerances, by forming these materials into desired shapes and sizes. The articles can be manufactured into infinite shapes and sizes using conventional forming and molding methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopants, doping parameters, and/or base resin section(s).

The conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, economers, or the like, and/or of metal powders such as nickel, copper, silver, aluminum, nichrome, or plated or the like. The use of carbons or other forms of powders such as graphite(s) etc. can create additional low level electron exchange and, when used in combination with micron, conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also, be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit, flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

The molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the molded conductively doped resin-based material, any of several techniques may be used to form this metal layer. This metal layer may he used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency, in addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire cart easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application, of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can he used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic, binders or alloying elements.

A ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include fertile, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may he combined with a non-ferromagnetic conductive doping to form a conductively doped resin-based material that combines excellent conductive qualities with magnetic capabilities.

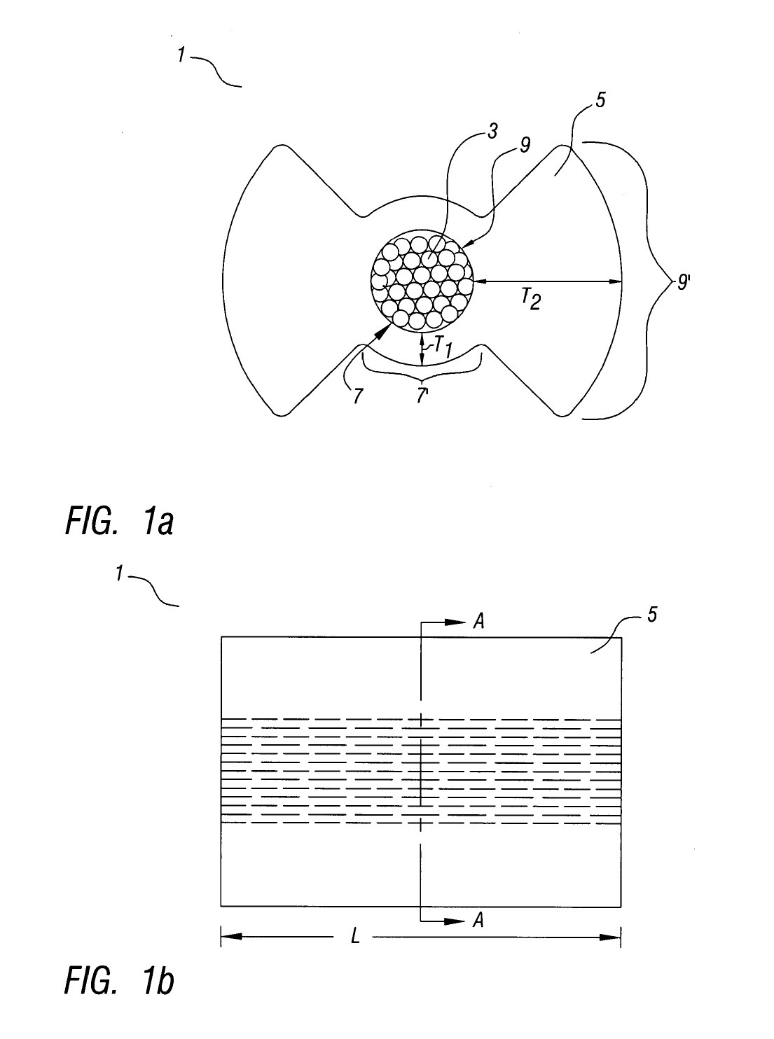

Referring now to FIGS. 1a and 1b, a preferred embodiment of a moldable capsule 1 of the present invention is illustrated. FIG. 1a shows a cross-section taken perpendicular to the length of the moldable capsule and indicates a “bowtie-shaped” type of cross-section. FIG. 1b shows a lengthwise side view of the moldable capsule. Referring particularly to FIG. 1a, several important features of the present invention are shown and are discussed below.

This moldable capsule 1 includes a bundle 3 of micron conductive fibers. The bundle 3 may be metal fiber or metal plated fiber. Metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating, materials include, but are not limited to, copper, nickel, cobalt, silver, gold, palladium, platinum., ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, organic fibers, cellulous, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

An exemplary list of micron wire materials includes: copper, alloys of copper such as coppered alloyed with any combination of beryllium, cobalt, zinc, lead, silicon, cadmium, nickel, iron, tin, chromium, phosphorous, and/or zirconium, and copper clad in another metal such as nickel; aluminum and alloys of aluminum such as aluminum alloyed with any combination of copper, magnesium, manganese, silicon, and/or chromium; nickel and alloys of nickel including nickel alloyed with any combination of aluminum, titanium, iron, manganese, and/or copper; precious metals and alloys of precious metals including gold, palladium, platinum, platinum, iridium, rhodium, and/or silver; glass ceiling alloys such as alloys of iron and nickel, iron and nickel alloy cores with copper cladding, and alloys of nickel cobalt, and iron; refractory metals and alloys of refractory metals such as molybdenum, tantalum, titanium, and/or tungsten; resistive alloys comprising any combination of copper, manganese, nickel, iron, chromium, aluminum, and/or iron; specialized alloys comprising any of combination of nickel, iron, chromium, titanium, silicon, copper clad steel, zinc, and/or zirconium; spring wire formulations comprising alloys of any combination of cobalt chromium, nickel, molybdenum, iron, niobium, tantalum, titanium, and/or manganese; stainless steel comprising alloys of iron and any combination of nickel, chromium, manganese, and/or silicon; thermocouple wire formulations comprising alloys of any combination of nickel, aluminum, manganese, chromium, copper, and/or iron.

The micron conductive fibers 3 have diameters of between about 3 and 12 microns, and typically between about 8 and 12 microns. The length(s) that can be seamless or overlapping.

The micron fiber may be pretreated, prior to forming the moldable capsule, to improve performance. For example, conductive or non-conductive powders may be leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment of fiber modification also reduces levels of particle dust, fines, and fiber release during subsequent capsule sectioning, cutting or vacuum line feeding.

A resin-based material layer 5 overlies the bundle 3 along the length L of the moldable capsule. The resin-based structural material may be any polymer resin or combination of compatible polymer resins. Non-conductive resins or inherently conductive resins may be used as the structural material. Conjugated polymer resins, complex polymer resins, and/or inherently conductive resins may be used as the structural material. Bio-resins, such as those manufactured from corn-oil, may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based material 5 preferably comprises a single resin-based polymer material that is moldable. A number of specific resin-based materials 5 useful for this embodiment are described herein. According to other embodiments, the resin-based material 5 further includes additives, lubricants, colorants, plasticizers, and micron conductive fibers and powders, in any combination.

The resin-based layer 5 is uniquely disposed onto the bundle 3. As is shown clearly in the cross-sectional representation of FIG. 1a, the resin-based layer 5 has a non-uniform thickness. In the illustrated embodiment, the resin-based layer 5 has a first thickness T₁ and a second thickness T₂. The first thickness T₁ is disposed around first surfaces 7 of the bundle 3. The second thickness T₂ is disposed around second surfaces 9 of the bundle 3. A thin, first section 7′ of the resin-based material layer 5 is disposed onto the first surface 7, and a thick, second section 9′ of the resin-based material layer 5 is disposed around the second surface 9. The second thickness T₂ is at least twice as thick as the first thickness T₁. In the illustrated embodiment, there are two “thin” sections 7′ of resin-based material and two “thick” sections 9′. The resulting cross-section of the moldable capsule is like a “bowtie” and is therefore called the “bowtie-shaped” capsule. Referring to FIG. 1b, the capsule has length L of between about 2 mm and 14 mm.

As an important feature of the present invention, the above-described variable-thickness moldable capsule 1 provides several key advantages for the present invention. First, when the moldable capsule 1 is subsequently melted and mixed, the relatively thin resin sections T₁, act as rapid “time release” points where the resin-based material layer 5 rapidly melts through and come apart to thereby release the conductive loading 3. As a result, the variable-thickness moldable capsule is found to more easily substantially homogenize during melting and mixing than a moldable capsule of a single thickness (i.e., having a round cross-section). Second, because the moldable capsule 1 includes thicker sections T₂ as well as the thinner “release” sections T₁, the overall capsule can be made to include a substantial volume of resin such that the above described, “salt and pepper” mixing is not needed. The excellent load release and mixing capabilities of the variable-thickness moldable capsule 1, reduce breakage or shearing of the micron conductive fiber while facilitating substantial homogenization of the micron fiber and the resin-based material. The novel moldable capsule facilitates no-shear, homogenized blending at normal screw speeds and back-pressures.

Referring now to FIG. 2, another preferred embodiment of the present invention is shown. Here, a “gear-shaped” moldable capsule 15 is illustrated. Resin-based material layer 16 overlies the bundle 17 of micron conductive fiber along the length of the moldable capsule as in the prior embodiment. The resin-based material layer 16 has first thickness T₁ and second thickness T₂. A thin, first section 19′ of the resin-based material layer 16 is disposed onto the first surface 19, and a thick, second section 21′ of the resin-based material layer 16 is disposed around the second surface 21. The second thickness T₂ is at least twice as thick as the first thickness T₁. In the illustrated embodiment, there are four “thin” sections 19′ of resin-based material and four “thick” sections 21′. The resulting cross-section of the moldable capsule is like a “gear” and is therefore called the “gear-shaped” capsule.

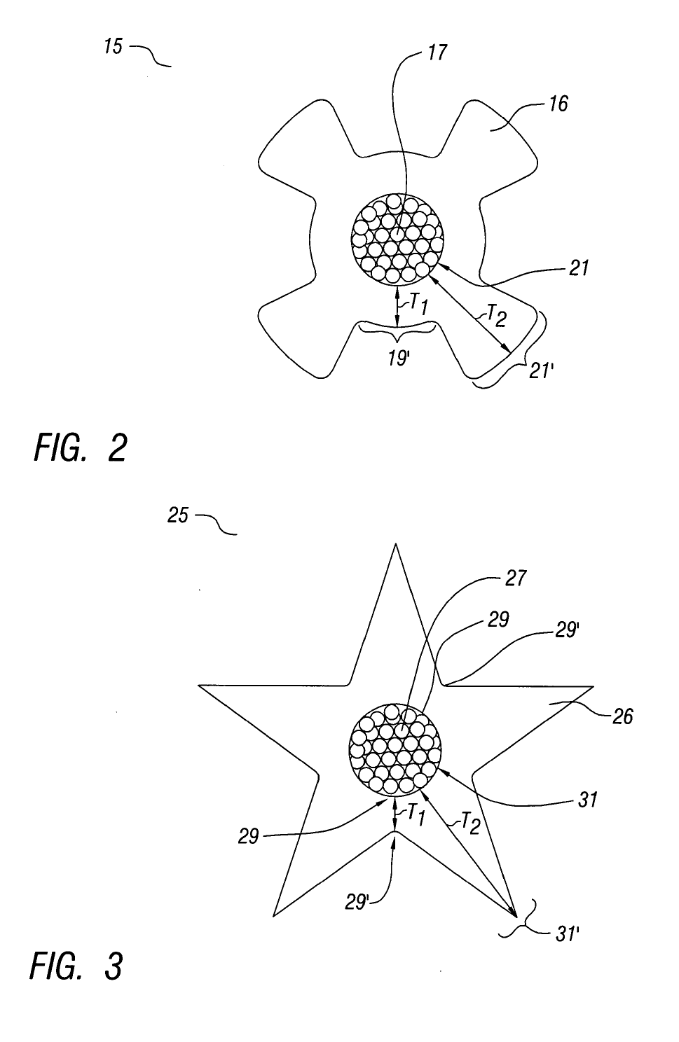

Referring now to FIG. 3, another preferred embodiment of the present invention is shown. Here, a “star-shaped” moldable capsule 25 is illustrated. Resin-based material layer 26 overlies the bundle 27 of micron conductive fiber along the length of the moldable capsule as in the prior embodiment. The resin-based material layer 26 has first thickness T₁ and second thickness T₂. A thin, first section 29′ of the resin-based material layer 26 is disposed onto the first surface 29, and a thick, second section 31′ of the resin-based material layer 26 is disposed around the second surface 31. The second thickness T₂ is at least twice as thick as the first thickness T₁. In the illustrated embodiment, there are five “thin” sections 29′ of resin-based material and five “thick” sections 31′. The resulting cross-section of the moldable capsule is like a “star” and is therefore called the “star-shaped” capsule. Other possible cross-sectional shapes of variable-thickness moldable capsules will be clear to those skilled in the art.

By carefully controlling the percentage, by weight, of the bundle so the moldable capsule within the above-described ranges, the present invention creates a novel moldable-capsule. This moldable capsule has a unique formulation and exhibits several exceptional and unexpected features not found in the prior art. The moldable capsule of the present invention utilizes a much smaller percentage, by weight, of conductive doping than the concentrate pellets of the prior art. The novel formulation of the moldable capsule of the present invention results in a moldable capsule that can be directly molded to form articles without mixing with a pure, or non-loaded, pellet as in the prior art. By substantially reducing the conductive doping in the conductive element core, the relative amount of resin-based material available for molding is increased. It is found that the novel formulation of the present invention contains sufficient resin-based material for excellent moldability without, the addition of “pure” plastic pellets. This feature reduces manufacturing part count and complexity while eliminating the inter-plastic mismatching, bonding problems, non-homogeneous mixture tendencies, and potentially dangerous chemical interactions found in the prior art. The novel formulation of the present invention insures that articles molded have sufficient resin-based material front the moldable capsule alone to exhibit excellent physical, structural, and chemical properties inherent, in the base resin.

Further, the novel formulation moldable capsule of the present invention further provides an optimal concentration of conductive doping to achieve high electrical conductivity and exceptional performance characteristics within the EMF or electronics spectrum(s) for many applications including antenna applications and/or EMI/RFI absorption applications. The novel formulation also results in excellent thermal conductivity, acoustical performance, and mechanical performance of molded articles. The novel formulation creates a conductively doped, composition and a doping concentration that creates an exceptional conductive network in the molded article. The novel formulation insures that the resulting molded article achieves sufficient conductive doping from the moldable capsule, alone, to exhibit excellent electrical, thermal, acoustical, mechanical, and electromagnetic properties from a well-formed conductive network within the resin-based polymer matrix.

Further, the novel formulation of the present invention creates a moldable capsule 200 exhibiting an optimal time release capability. The moldable capsule incorporates a relatively large amount of resin-based material extruded onto and permeating into the micron conductive fiber core. The greater amount, by weight, of resin-based material, when compared to the prior art, results in a larger volume of resin-based, material that must melted in the mixing and compression section of an extruder prior to fiber release. As a result, an optimal time release property is achieved. The inner micron conductive fiber is dispensed and dispersed into the melted composite mixture at the right time and place in the mixing/molding cycle to minimize extruder induced damage to the fiber. Therefore, the moldable capsules can be mixed, melted, and substantially homogeneous more easily without damaging the fiber doping. Problems of non-homogenous mixing, fiber damage, fiber clumping, ganging, balling, swirling, hot spots and mechanical failures are eliminated.

The release, or separation, of the fiber strands of conductive element(s) from the outer, resin-based material is a critical stage in preparing a conductively doped, resin-based material for molding. The release and substantial homogenization of fiber and polymer affects not only the structural integrity of the molded conductively doped resin-based material, but also affects material conductivity. If the fiber separation is too fast, as in the prior art, the fiber will experience undo breakage, disruptive orientation, and will not be homogenized with the base resin evenly. These detrimental effects are due to the combination of high rotation speed of the screw, barrel friction, nozzle design and other pressures or forces exerted on the materials during mixing, melting, and compression prior to injection into a die or mold. The novel design of the moldable capsules of the present invention controls the timing sequence and the orientation for the fiber release cycle to thereby accurately and evenly dispense the conductive elements within the base resin. As a result, an excellent conductive network is substantially homogeneously formed in the molded article.

Further, the novel design of the moldable capsule of the present invention is very well, suited for use with a micron conductive fiber core comprising micron conductive fibers. The orientation of the micron conductive fibers, such as random, omni-directional, or parallel, in the molded conductively doped resin-based article can significantly affect the performance of the article. As is known in the art, mold design, gating, protrusion designs, or other means within the molding apparatus, may be used to control the orientation of dopant materials incorporated into a resin-based material. The variable-thickness moldable capsules of the present invention are particularly useful in facilitating the ability to control fiber directionality due to the ease with which initial homogenization occurs without over-mixing.

Further, the novel design of the moldable capsule of the present invention provides a homogeneously mixed composite material of conductive elements and base resin that is optimized to maximize molecular interaction between the base resin polymer and the conductive elements. Equalization and intertwining of the network of conductive elements with the base resin, molecular chains results in enhanced molecular properties in the base resin polymer chain including physical, electrical, and other desirable properties.

The conductive fiber of the present invention creates a high aspect ratio conductive element such that individual fiber elements easily overlap with each other. As a result, the conductive lattice exhibits electron exchange capability on par with low resistance, pure metals such as copper. By comparison, conductive powders present essentially no aspect ratio for overlapping. Therefore, a very high conductive powder doping must be used to generate a low resistance molded material. However, this doping must be so large that it disrupts the resin, polymer chain structures and results in a molded part with very poor structural performance. Conductive flakes present a better aspect ratio than powders but still do not provide the combined low resistance and sound structural performance found In the present invention.

Further, the novel design of the moldable capsule of the present invention is compatible with, and extendable in scope to, a variety of micron conductive fibers, a variety of micron conductive powders, and a variety of combinations of micron conductive fibers and/or powders. The overall bundle comprises many individual fiber strands routed together in parallel. Hundreds, thousands, or tens of thousands of fibers are thus routed to form the cord. The length of the bundle corresponds roughly to the length of the moldable capsule since a common segmentation step cuts through both the conductive element core and the outer resin-based material.

The bundle comprises conductive fiber and/or conductive powder. In one embodiment of the present invention, the conductive fiber and/or conductive powder comprise metal material. More particular to the present invention, this metal material is preferably in any form of, but not limited to, pure metal, combinations of metals, metal alloys, metal-clad onto other metal, and the like. More particular to the present invention, this metal material is combined with the resin-based material using an extrusion/pultrusion method. As is described in these embodiments, the bundle preferably begins as a bundle of very fine wire called a micron fiber bundle. The resin-based material is extruded onto this micron fiber bundle and then segmented to form the novel molding capsules of the present invention.

Within this preferred embodiment wherein the conductively doped material comprises a micron wire bundle, it is common to specify this type of material in terms of feet per pound. It is relatively straightforward to convert the desired percent by weight, of the conductive doping into the feet per pound regime. When the micron wire bundle is encapsulated in the resin-based material, yet prior to segmentation, the combined micron wire bundle-and base resin combination bears a combined feet per pound (X_{Total}). The original feet per pound of the micron wire bundle only (X_{Wire}) should be known. By inverting these quantities, the weight per foot of each can be derived as 1/X_{Total} and 1/X_{Wire}. The desired percent weight of conductive doping can then be selected according to:

Percent weight=(1/X_{Wire})/(1/X_{Total}).

A number of specific micron conductive fibers and micron conductive powders useful for this embodiment are described herein. Again, the micron conductive fiber preferably comprises a bundle, or cord, of fibers stacked or routed in parallel or twisted around a central axis. In the illustration, a few such micron conductive fibers are shown. In practice, hundreds, or tens of thousands of fibers are used to create a bundle or cord. If combined with a bundle of micron conductive fibers, the micron conductive powder is preferably leeched into the bundle of fibers as is described above. The micron conductive powder, along with the micron conductive fiber, acts as a conductor in the conductive network of the resulting molded article. In this case, the percentage, by weight, of the combined micron conductive fiber and micron conductive powder in the moldable capsule is formulated and controlled within the ranges herein described. In addition, the micron conductive powder may act as a lubricant in the molding machine.

As another preferred embodiment, the resin-based material is further loaded with micron conductive powder as described in the method above. Again, the micron conductive fiber in the core preferably comprises a bundle, or cord, of fibers stacked or routed in parallel or twisted around a central axis. In the illustration, a few such micron conductive fibers are shown. In practice, hundreds, or fens of thousands of fiber strands are used to create a bundle or cord. The micron conductive powder in the resin-based material is released when the resin-based material melts. The micron conductive powder acts as a conductor, along with the micron conductive fiber, in the conductive network of the resulting molded article. Again, the percentage, by weight, of the combined micron conductive fiber and micron conductive powder in the moldable capsule is formulated and controlled within the ranges herein described. In addition, the micron conductive powder may act as a lubricant in the molding machine.

The several embodiments of moldable capsules according to the present invention are easily molded into manufactured articles by injection molding, extrusion molding, compression molding and the like. The resulting molded articles comprise an optimal, conductively doped resin-based material. This conductively doped resin-based material typically comprises a micron powder(s) of conductor particles and/or in combination of micron fiber(s) substantially homogenized within a base resin host.

More particularly, in one embodiment, the micron conductive fiber bundle comprises between about 5% and about 50% of the total weight of the wire-like cable 22, In a more preferred embodiment, the micron conductive fiber core comprises between about 20% and about 50% of the total weight of the moldable capsule. Low density micron conductive fibers, such as metal plated carbon fiber, may require relatively loading percentages than higher density all-metal fibers, such as stainless steel. In another preferred embodiment of the present invention, the conductive doping is determined by volume percentage. In another preferred embodiment, the conductively doping comprises a volume of between about 1% and about 50% of the total volume of the conductively doped resin-based material though the properties of the base resin may be impacted by high percent volume doping. In a more preferred embodiment, the conductive doping comprises a volume of between about 4% and about 10% of the total volume of the conductively doped resin-based material.

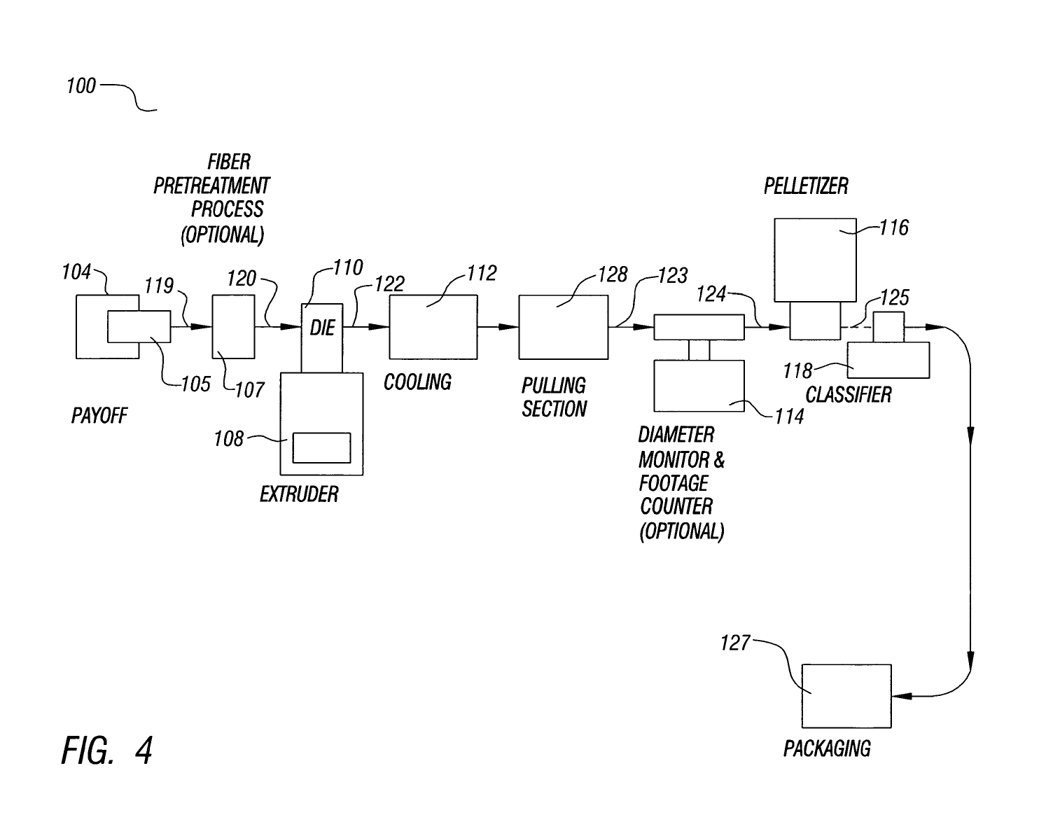

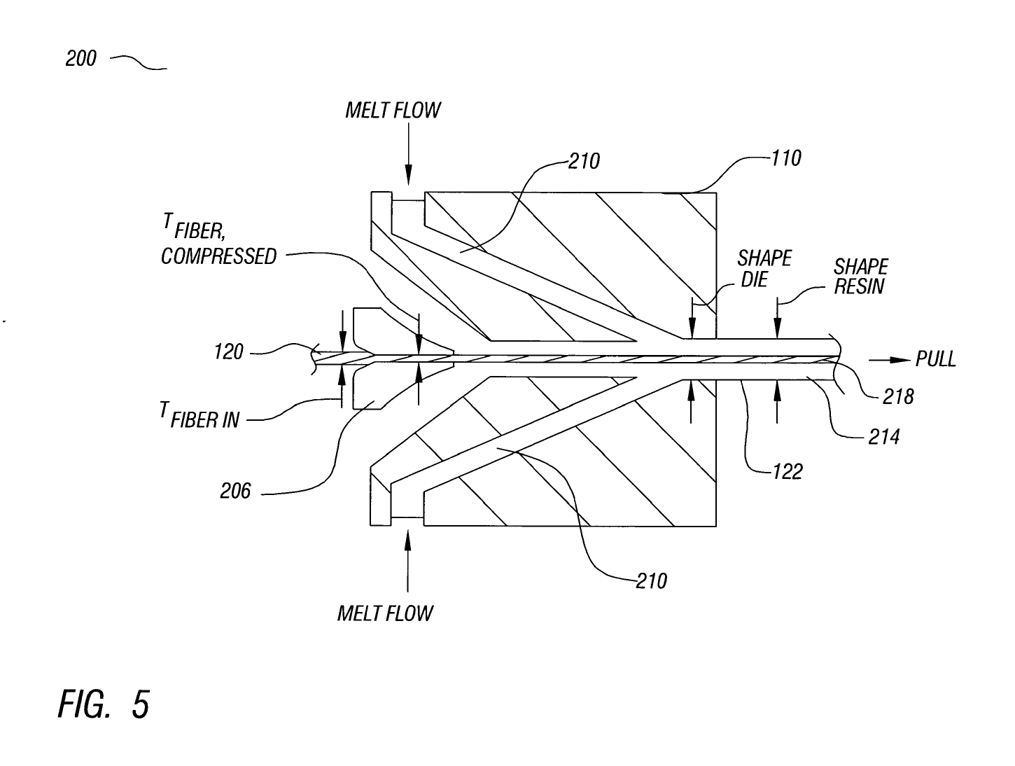

Referring now to FIG. 4, another preferred embodiment of the present invention is illustrated. A schematic 100 of a manufacturing flow for forming a unique, moldable capsule via the present invention is illustrated. In this method, an extrusion/pultrusion process is used to extrude a base resin onto a continuous conductive micron fiber bundle. After extrusion/pultrusion, the combined fiber and resin cable is pelletized into moldable capsules.

In the illustrated embodiment, a reel of micron conductive fiber 105 is loaded onto a payoff apparatus 104. The micron conductive fiber 119 preferably comprises multiple, parallel strands of micron conductive fiber. Each strand of micron conductive fiber is preferably in the range of between about 6 and about 12 microns. In diameter. The bundle 119 preferably comprises up to tens of thousands of strands of fiber.

The micron conductive fiber bundle 119 is routed into the extrusion die 10. In some embodiments of the process, however, it is useful to pre-process the fiber handle 119 prior to extrusion. A pretreatment process 107, or combination of processes, is performed to enhance the characteristics of the fiber bundle 119 prior to extrusion. Pretreatment processes include, but are not limited, leeching processes that add materials to the bundle and chemical modification processes that improve the fibers interfacial properties.

In one embodiment of a leeching pretreatment process 107, the micron conductive fiber 119 from the payoff reel 105 is first routed into a powdering apparatus 107 prior to routing into the extrusion apparatus 108 and 110. The powdering apparatus 107 preferably comprises a solution comprising micron conductive powder suspended in a liquid media. As the fiber bundle 119 is fed through the liquid media, the micron conductive powder in the solution leeches into the micron conductive fiber 119. The resulting treated fiber bundle 120 is thereby impregnated with micron conductive powder.

There are several embodiments of inert chemical modification processes that improve the fibers interracial properties. Treatments include, but are not limited to, chemically inert coupling agents, gas plasma, anodizing, mercerization, peroxide treatment, bensoylation, and other chemical or polymer treatments. A chemically inert coupling agent is a material that is bonded onto the surface of metal fiber to provide an excellent coupling surface for later bonding with the resin-based material. This chemically inert coupling agent does not react with the resin-based material. An exemplary chemically inert coupling agent is silane. In a silane treatment, silicon-based molecules from the silane molecularly bond to the surface of metal fibers to form a silicon layer. The silicon layer bonds well with the subsequently extruded resin-based material yet is chemically inert with respect to resin-based materials. The unpredictable and damaging chemical interactions exhibited in the prior art “salt and pepper” mix are thereby avoided. As an optional feature during a silane treatment, oxane bonds with any water molecules on the fiber surface to thereby eliminate water from the fiber strands. Silane, amino, and silane-amino are-three exemplary pre-extrusion treatments for forming chemically inert coupling, agents on the fiber.

In a gas plasma treatment the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing and preventing oxide growth (when compared to non-treated fiber). Pretreatment fiber modification may also reduce levels of dust, fines, and fiber release during subsequent pellet cutting or vacuum fed feeders. After the optional pretreatment, the treated micron fiber bundle 120 is routed into the extruder die 110.

The extruder 118 and 110 is used to form resin-based material onto the fiber bundle 120. Several important features of the extruder 108 and 110 are described herein. Referring now to FIG. 7, another preferred embodiment of the present invention is illustrated showing an extrusion machine, or extruder. The extruder comprises a hopper unit 320. Resin-based molding material is loaded into the hopper unit 320. In one preferred embodiment, the resin-based molding material comprises pure resin-based material in the form of pellets, sheets, rods, or lumps. In other preferred embodiments, various additives, lubricants, colorants, plasticizers, and other materials typical to the art of plastic molding are added to the resin-based material n the hopper 320. In yet other preferred embodiments, micron conductive powders and/or fibers are added to the resin-based material in the hopper 320. In other preferred embodiments, a pre-compounded resin-based material, where the resin-based material is pre-mixed with a combination of additives, lubricants, colorants, plasticizers, conductive powders and fibers, is loaded into the hopper 320. In another preferred embodiment of the present invention, the resin-based hopper load is constantly fed at a rate to sustain high-volume extrusion of resin-based material onto the continuous fiber bundle. Any of a number of known material conveyances may be used, such as gravity feeders, vibratory feeders, and the like.

The hopper 320 feeds the resin-based material into a barrel 310 and screw 315 mechanism. The screw 315 is essentially a large auger that fits closely inside of the barrel 310. A motor 330 turns the screw 315 inside the barrel chamber 310 to create a combination material feeding, heating, and mixing effect. The barrel 310 is heated by this turning friction and by heaters 325 that are distributed around the barrel 310. The screw 315 and barrel 310 convey the resin-based material away from the hopper 328 and toward the mold 335. In the mixing section of the screw 315 and barrel 310, the primarily actions are mixing and heating of the resin-based material. Melting begins to occur but without compression. In the subsequent compression section, the resin-based material is completely melted. Compression, of the molten blend begins. In the subsequent metering section, the final mixing and homogenization of the resin-based material and all additives, lubricants, colorants, plasticizers, conductive fillers, and the like, is completed to generate physically homogenized material. The resin-based material is then forced through a crosshead die 335. In the crosshead die 335, the resin-based material converges on the micron fiber bundle. The micron, conductive fiber bundle 20 is routed through the hollow core or ring 340 of the die 335 such that molten resin-based material surrounds the bundle and is extruded onto the bundle as the bundle passes through.

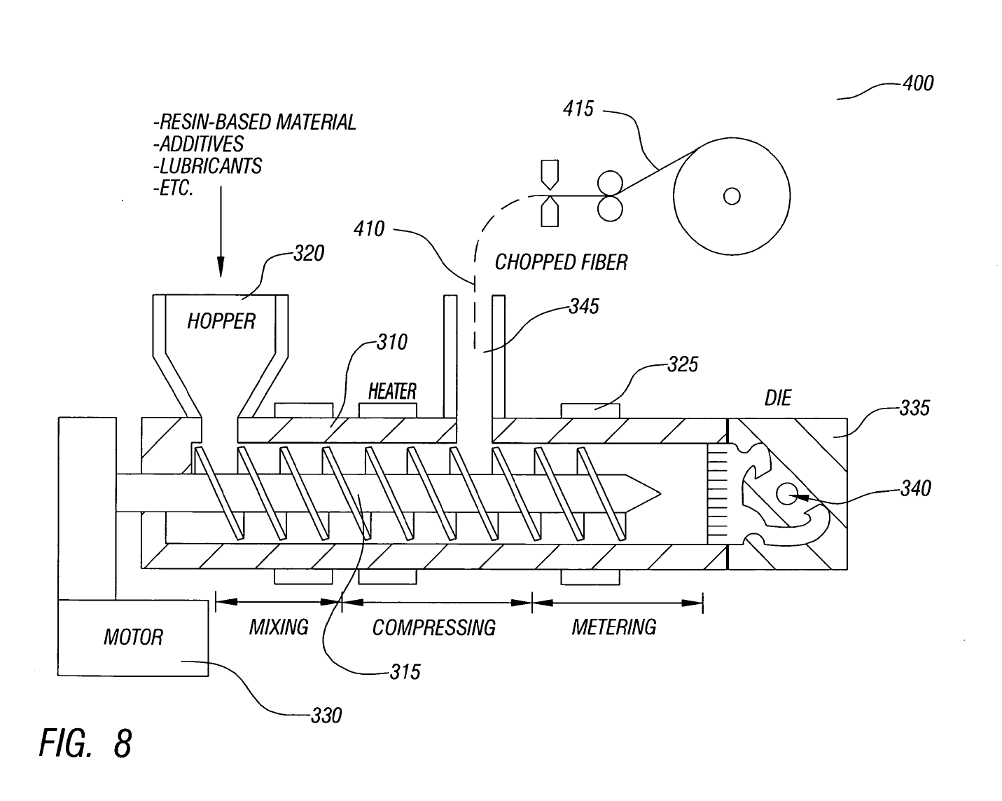

An optional down stage input 345 is shown on the extruder barrel 310. This additional material input is useful for adding components to the resin-based material after the main mixing and compressing sections of the barrel 310. Referring now to FIG. 8, in another preferred embodiment 400, a down stage input is used. In this embodiment, the resin-based material is loaded into the hopper 320 as before. In this case, however, chopped micron conductive fiber 410 is added through the down stage input 345 to the resin-based material moving through the screw 315 and barrel 310. In the preferred embodiment, a micron conductive fiber bundle 415, similar to that described for the main micron fiber bundle, is unwound from a spool and then chopped into specified lengths. The chopped fiber 410 becomes part of the resin-based material that is routed into the crosshead die 335. It may be preferable to add chopped micron fiber, or other similar components, to the resin-based material in the screw 315 and barrel 310 after the primary mixing and compression stages to thereby minimize fiber damage due to mixing and compressing forces. In this embodiment, the chopped fiber 410 is added by gravity feed. This approach is well suited to adding conductive fiber such as metal or metal plated fiber to the moldable mixture.

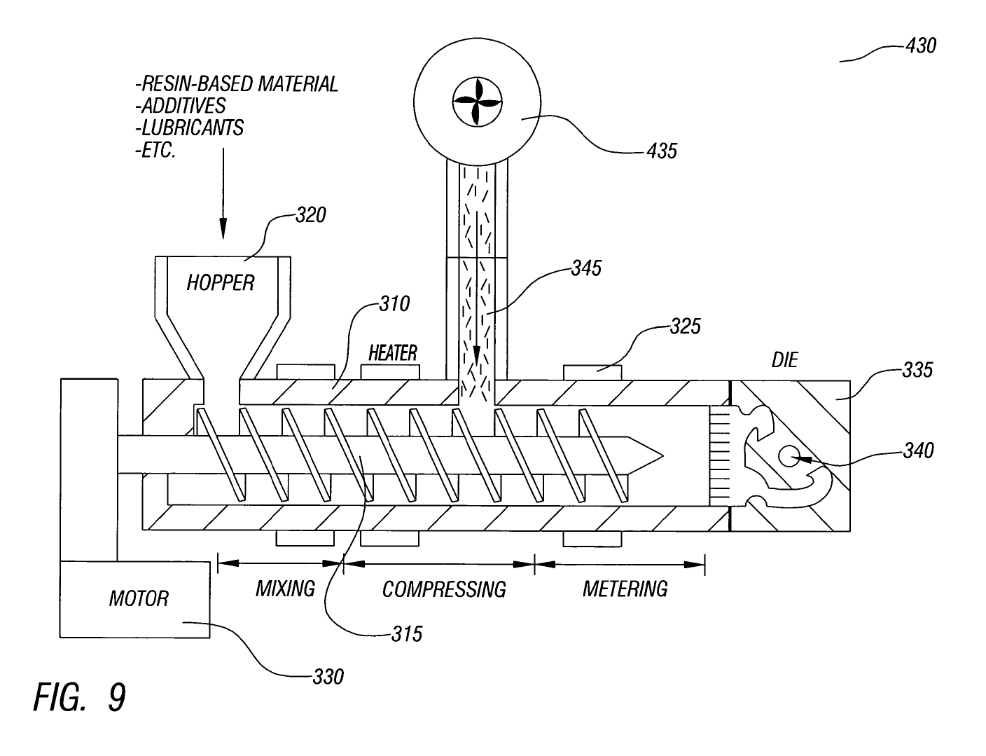

Referring now to FIG. 9, another preferred embodiment 430 of the present invention shows another method to load fiber through the downstage input. In this embodiment, chopped fiber is blown into the screw 315 and barrel 310 mechanism through the down stage input 345 via a blowing or gun mechanism 435. This approach is well suited for loading fibers into the resin-based material. Again, by delaying the introduction of fibers until after primary mixing and compression, fiber damage is minimized. Alternatively, a twin screw extruder is used. A twin-screw extruder has two screws that are arranged side-by-side and rotate in an intermeshing pattern that typically looks like a “FIG. 8” in end view. The intermeshing action, of the two screws constantly self-wipes the screw flights or inner barrel surfaces. A single screw extruder may exhibit difficulty with resin-based material adhering to the barrel sidewalls or flaking. However, a twin-screw extruder forces the resin-based material to follow the figure eight pattern and thereby generates a positive pumping action for all forms of resin-based material. As a result, a twin screw extruder is typically capable of operating at faster extrusion rates than a single screw extruder.

Referring now to FIG. 5, a preferred embodiment of a crosshead die 200 of the present invention is illustrated in cross-sectional view. Several features of the crosshead die and the method of extruding should be noted. An opening is made through the die 200 to allow the micron fiber bundle 120 to pass through. The bundle 120 passes routing channels containing the melted resin-based material 210.

As an optional feature, the incoming fiber bundle 120 may be compressed prior to resin extrusion. The incoming fiber bundle 120 has a relatively thick diameter T_{FIBERIN}. Although each fiber strand is aligned in parallel, there are air gaps between the strands. Prior to entering the crosshead die 210, the bundle 120 passes through a compression ring 206. The compression ring 206 progressively forces the fiber strands together and puts a compression force on the collective bundle. As a result, the outer diameter is reduced to T_{FIBER,COMPRESSED} as the compressed bundle 218 exits the compression ring 206. By incorporating the novel step of compressing the fiber bundle 120, prior to extrusion coating with the molten resin-based material, several advantages are derived. First, the compression introduces an initial force onto the compressed bundle 218. After the resin-based material coats onto the compressed bundle 218, the fiber strands mechanically rebound against the resin-based material 214. This compression rebounding effectively locks together the fiber bundle 218 and the resin-based coating 214 in to what is herein called an extruded bundle 122. The compression/rebound effect is particularly important where a fiber material is selected that does not chemically bond well with the selected resin-based material. Second, during subsequent cutting, or pelletizing, of the extruded bundle, the compressed fiber 218 will be well-retained, or locked. In the resin-based outer covering 214. The fiber is also locked into the resin-based material during subsequent handling of the palletized, moldable capsules. This fiber retention mechanism is accomplished without coating the fiber bundle with a different resin-based material prior to extrusion. Therefore, additional processing expense is avoided and, more importantly, adverse interactions of dissimilar resin-based materials, as described in the prior art, are avoided. As an important additional advantage, if is found the moldable capsule formed using this pro-compressing process exhibits excellent fiber release-during molding operations.

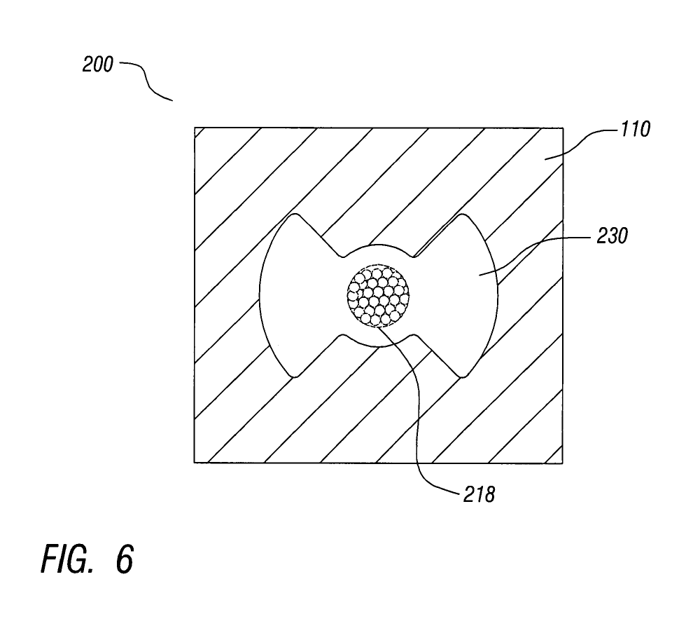

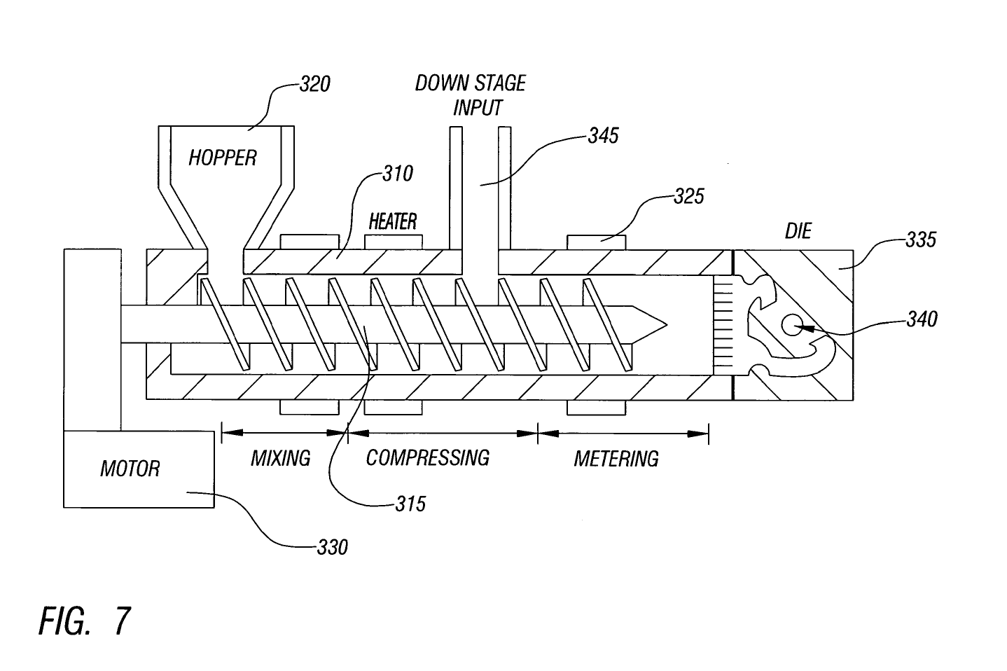

A controlled shape (SHAPE_{RESIN}) of resin-based material 214 is extruded onto the compressed bundle 218. The resulting shape is determined by the shape of the die opening (SHAPE_{DIE}). By processing the compressed bundle 218 and resin-based material 214 through the die, a desired cross-sectional shape (SHAPE_{RESIN}) of the extruded resin cable 122 is achieved. The die shape is. carefully designed to produce extruded resin cable 122, and, subsequently, moldable capsules, with a particular percentage of micron conductive fiber, by weight, to optimize performance of articles molded with the moldable capsules. Referring now to FIG. 6, a cross section of the die 200 is shown. The die structure 110 has an opening 230 machined to the desired cross-sectional shape of the moldable capsules. The pultrusion apparatus, not shown, pulls the bundle of micron conductive fiber 218 through the center of the die outlet 230 such that the bundle is centered in the extruded material. Finally, the variable-thickness moldable capsules resulting from the process exhibit excellent time release and homogenization qualities during pre-mold melting.

Referring again to FIG. 5, the extrusion/pultrusion process of the present invention produces a continuous extruded bundle 122 comprising a micron fiber bundle 218 with a resin-based material 214 extruded thereon. In alternative embodiments, the micron fiber bundle 218 further comprises embedded micron conductive powder that is leeched into the bundle 218 prior to extrusion. In another embodiment, the micron fiber bundle 218 further comprises a chemically inert coupling agent to aid in bonding between fiber and resin-based material. In another embodiment, the micron fiber bundle has been anodized to prevent further oxidation effects on the fiber surface. In another embodiment, the micron fiber bundle has been etched to improve surface adhesion between fiber and resin-material. In another embodiment, the resin-based material further comprises conductive doping, such as micron conductive fiber or powder, such that the extruded bundle carries conductive doping both in the core bundle 218 and in the extruded covering 214.

Referring, again to FIG. 4, the extruded bundle 122 passes through a cooling process 112. The cooling process 112 reduces the temperature of the extruded bundle 122 by spraying with or immersing the bundle 122 in fluid such as water. The cooled extruded bundle 123 is pulled along by a pulling section 128. Preferably, the process 102 operates as a high-speed pulled-extrusion/pultrusion method similar to that used in the manufacture of conductive wiring. By pulling the cooled extruded bundle 123, the entire length of the micron conductive bundle is placed under tension. This tension allows the overall process to operate at high speeds without kinking or binding.

As an optional feature, the cooled extruded bundle 123 is processed through a control monitor 114 to verify the outer diameter, or other shape features, of the cooled extruded bundle 123 and to count the overall length. The cooled extruded bundle 123 is then fed into a segmentation apparatus 116, or pelletizer, where the cooled extruded bundle 123 is segmented into individual moldable capsules 125. The moldable capsules 125 are preferably segmented to a length of between about 2 millimeters and about 14 millimeters although longer or shorter lengths may be used. The segmenting method may be by cutting, sawing, chopping, stamping, and the like. The moldable capsules 125 retain the same percent, by weight, specification as the cooled extruded bundle 123. The segmented capsules 125 are processed through a classifier 118, separator, or screen, to remove any lose fiber, miss-cut pieces, tape, or other unwanted materials while retaining intact moldable capsules 125. Finally, the classified moldable capsules are packaged 127.

The advantages of the present invention may now be summarized. An effective, variable-thickness moldable capsule useful for molding conductively doped resin-based articles is provided. The moldable capsule exhibits optimal properties for time-releasing conductive material into the resin-based material during melting and mixing during the molding cycle. The moldable capsule has “rapid release” points that aid in substantially homogenization during melting and mixing. The overall capsule can be made to include a substantial volume of resin such that the above described, “salt and pepper” mixing is not needed. The excellent load release and mixing capabilities of the variable-thickness modable capsule reduces breakage or shearing of micron conductive fiber while facilitating low to moderate pressure operation of a molding screw apparatus.

While the invention has been particularly shown and described with reference to the preferred embodiments thereof, it will be understood by those skilled in the an that various changes in form and details may be made without departing from the scope of the invention.

What is claimed is:

1. A moldable capsule device comprising:
a bundle of micron conductive fiber; and
a resin-based material layer overlying the bundle along the length of the capsule wherein thickness of the resin-based material layer is not uniform.

2. The device according to claim 1 wherein the resin-based material layer has a first thickness and a second thickness and wherein the second thickness is at least twice that of the first thickness.

3. The device according to claim 2 wherein the first thickness is disposed around a first surface of the bundle and the second thickness is disposed around a second surface of the bundle.

4. The device according to claim 2 wherein the first thickness is disposed around multiple first surfaces of the bundle and the second thickness is disposed around multiple second surfaces of the bundle.

5. The device according to claim 4 wherein the cross-section of the moldable capsule is “bowtie-shaped”.

6. The device according to claim 4 wherein the cross-section of the moldable capsule is “gear-shaped”.

7. The device according to claim 4 wherein the cross-section of the moldable capsule is “star-shaped”.

8. The device of claim 1 wherein the resin-based material further comprises a micron conductive powder.

9. The device of claim 1 wherein the bundle further comprises micron conductive powder.

10. The device of claim 1 wherein the bundle is between about 5% and 50% of the weight of the moldable capsule.

11. The device of claim 1 wherein the bundle is between about 20% and 50% of the weight of the moldable capsule.

12. The device of claim 1 wherein the bundle is between about 1% and 50% of the volume of the moldable capsule.

13. The device of claim 1 wherein the bundle is between about 4% and 10% of the weight of the moldable capsule.

14. A moldable capsule device comprising:
a bundle of micron conductive fiber; and
a resin-based material layer overlying the bundle along the length of the capsule wherein the resin-based material layer has a first thickness and a second thickness, wherein the first thickness is disposed around multiple first surfaces of the bundle and the second thickness is disposed around multiple second surfaces of the bundle, and wherein the second thickness is at least twice that of the first thickness.

15. The device according to claim 14 wherein the cross-section of the moldable capsule is “bowtie-shaped”.

16. The device according to claim 14 wherein the cross-section of the moldable capsule is “gear-shaped”.

17. The device according to claim 14 wherein the cross-section of the moldable capsule is “star-shaped”.

18. The device of claim 14 wherein the resin-based material further comprises a micron conductive powder.

19. The device of claim 14 wherein the bundle further comprises micron conductive powder.

20. The device of claim 14 wherein the bundle is between about 5% and 50% of the weight of the moldable capsule.

21. The device of claim 54 wherein the bundle is between about 20% and 50% of the weight of the moldable capsule.

22. The device of claim 14 wherein the bundle is between about 1% and 50% of the volume of the moldable capsule.

23. The device of claim 14 wherein the bundle is between about 4% and 10% of the weight of the moldable capsule.

24. A method to form a moldable capsule comprising:
extruding/pultruding a resin-based material layer onto the length of a bundle of micron conductive fiber wherein the resin-based material layer has a first thickness and a second thickness, wherein the first thickness is disposed around multiple first surfaces of the bundle and the second thickness is disposed around multiple second surfaces of the bundle, and wherein the second thickness is at least twice that of the first thickness; and
sectioning said extruded/pultruded resin-based material and said bundle into moldable capsules.

25. The method according to claim 24 wherein the cross-section of the moldable capsule is “bowtie-shaped”.

26. The method according to claim 24 wherein the cross-section of the moldable capsule is “gear-shaped”.

27. The method according to claim 24 wherein the cross-section of the moldable capsule is “star-shape”.

28. The method of claim 24 wherein the resin-based material further comprises a micron conductive powder.

29. The moldable capsule of claim 24 wherein the bundle further comprises micron conductive powder.

30. The method of claim 24 wherein, the bundle is between about 5% and 50% of the weight of the moldable capsule,

31. The moldable capsule of claim 1 wherein the bundle is between about 20% and 50% of the weight of the moldable capsule.

32. The moldable capsule of claim 24 wherein the bundle is between about 1% and 50% of the volume of the moldable capsule,

33. The moldable capsule of claim 24 wherein the bundle is between about 4% and 10% of the weight of the moldable capsule.

34. The method according to claim 24 further comprising the step of compressing the bundle of micron conductive fiber strands prior to the step of extruding/pultruding.

35. The method according to claim 24 farther comprising the step of pre-treating said bundle prior to the step of extruding/pultruding.

36. The method according to claim 35 wherein the step of pre-treating comprises forming a chemically inert coupling agent onto the bundle.

37. The method according to claim 35 wherein the step of pre-treating comprises anodizing the bundle.
